(19) United States
(12) Patent Application Publication
(10) Pub. No.: US 2003/0099760 A1
(43) Pub. Date: May 29, 2003

(54) Taste-improving agent and method of using the same

(76) Inventor: Hideo Okai, Higashi-Hiroshima Shi (JP)

Correspondence Address: WILLIAM J. DANIEL, 6100 WOODLAND TERRACE, MCLEAN, VA, 22101-4225, US

(21) Appl. No.: 10/284,279

(22) Filed: Oct. 31, 2002

(30) Foreign Application Priority Data
Nov. 7, 2001 (JP) 2001-377893

(51) Int. Cl. A23L 1/221

(52) U.S. Cl. 426/650

(57) ABSTRACT

Taste-improving agents which are basic neutral salts of citric acid and a basic amino acid reacting with citric acid to yield an essentially tasteless salt and preferably selected from the group consisting of arginine, lysine and ornithine. These basic neutral salts are tasteless in themselves but have the capability of when associated in small amounts with any of a broad variety of foods of modifying the taste characteristics of food in enhancing saltiness, reducing bitterness and ofttimes reducing sourness, increasing sweetness or the sensation of sweetness, increasing Umami and improving neutral salt taste. They are free of sodium and hence especially suitable for sodium-restricted diets by elevating the perception of saltiness in a sodium-free manner and without increasing bitterness. They can also be combined with pharmaceuticals or drugs intended for oral administration to counteract an unpleasant taste.

### INTRODUCTION

This invention relates to a taste-improving agent which in itself is tasteless but is adapted to improve the taste of foodstuffs as well as pharmaceuticals or drugs, particularly those drugs having a taste in need of improvement, especially bitterness or sourness, and is concerned more particularly with a taste-improving agent capable of promoting desirable tastes such as sweetness and saltiness and the more recently identified taste quality referred to as “Umami”.

### BACKGROUND

The search for ways of improving the taste of materials consumed by humans, represented mainly by foodstuffs, undoubtedly precedes recorded history and has, more recently, been extended to pharmaceutical agents or drugs taken by mouth. It hardly needs mentioning that for bland or rather “neutral” tasting foods, resort has been had for centuries to the addition of sodium chloride to impart a more distinctive or zesty flavor. And sweetness has been improved, or bitterness counteracted, by the addition of saccharides, e. g. sugar, or modern artificial sweetening agents. Desirable tartness or acidity has been achieved by means of vinegar going back again hundreds of years.

Much more recently, a new primary taste quality has been identified that in contrast to the traditional qualities, is not specifically identifiable in the mouth but in some fashion has the ability of improve the taste of a variety of foods and the like. The new taste quality has been given the name “Umami” and is now in wide-spread use in academic journals and the like throughout the world. It is illustrated by the familiar monosodium glutamate as well as sodium 5′-iosinate (5′-IMP) and sodium 5′-guanylic acid (5′-GAP). In almost all of these common instances, the effect or contribution of the flavoring additives is proportionate to the quantity that is added, thus calling for adjustment, usually increase, of the amount employed to achieve the desired result.

Considering foodstuffs intended for special purpose such as salt-restricted diets for persons suffering from hypertension for whom sodium intake is contra-indicated, potassium chloride has frequently replaced the sodium chloride of common table salt but at the cost of much of the unique flavor-enhancing saltiness of sodium chloride plus an added bitterness.

Those seeking to reduce their caloric intake and lose weight have adopted low sugar diets relying on artificial sweeteners such as saccharin and the like. Also, it is known to synergistically improve the Umami effect by a combination of sodium glutamate and sodium inosinate, both of which exhibit the Umami property.

It is clear that the search for substances for desirably modifying the taste appeal of food and drugs generally has been subject to a fairly limited choices. Hence, there is a real need for new ways of approaching this problem.

Of course, the prior art has recognized and utilized other materials in the course of this search. Among these are Trehalose (as described in Japanese Laid-Open Patent 2000-159788) and a yeast extract (revealed in Japanese Laid-Open Patent 2000-37170). These additives are purported to soften such taste qualities as pungency, bitterness, astringency, sweetness, etc., with a particular emphasis on sweetness. And mention certainly should be made of the familiar soy sauce. But in all these cases (and no doubt others as well), the substances have an inherent flavor or taste of their own which is passed on to foods to which they are added. Consequently, the natural flavor of the thus-treated foods is significantly altered which often is a disadvantage to those for whom the inherent flavor of some specific edible is of paramount importance.

Further, the newer additives that contain sodium among their constituents have serious health-drawbacks for e. g. the Japanese people who tend already to consume foods with large amounts of sodium in substances such as Miso-soybean paste or soy sauce itself. The negative effect is even more serious for those already with hypertensive symptoms or who suffer from diabetes. Thus, there is important need in the art for new and improved taste-improving agents free of such major negative characteristics.

Taste Characteristics of Representative Neutral Salts:

Surprisingly, it is certainly not generally a matter of common knowledge that more than 90% of the taste-improving substances found in the diet of more people are neutral salts formed of acids and bases (primarily sodium chloride), and that there are only relative few kinds of pure simple or uncombined substances, namely free acids, and certain sweet or bitter substances. The threshold levels for mouth perception by typical individuals of neutral salts (a typically example of which is NaCl) and of free acids are in the order of 10⁻³ M, and only a few sweet or bitter substances have threshold values below this magnitude. For example, the threshold level for brucine is in the order of 10⁻⁶ M while that for saccharine is in the order of 10⁻⁷ M. This indicates that only extremely minute amounts of such compounds are required for taste perception from which it follows that their taste-altering properties are extremely potent.

The fact that the taste threshold of most flavor additives (which are mainly neutral salts) is generally in the region of 10⁻³ M is quite significant in chemical terms. The value 10⁻³ M denotes the border region between a lean or dilute solution wherein the composite ions are free to move freely and a concentrated solution wherein the ions are densely held. This means that in their operative functioning condition, most of the usual taste-improving agents exist as bodies of ions in a congested or dense state at the site of the taste receptors in taste cells in the mouth. They are not therefore able to behave individually as is the case for ordinary chemical reactions under dilute conditions.

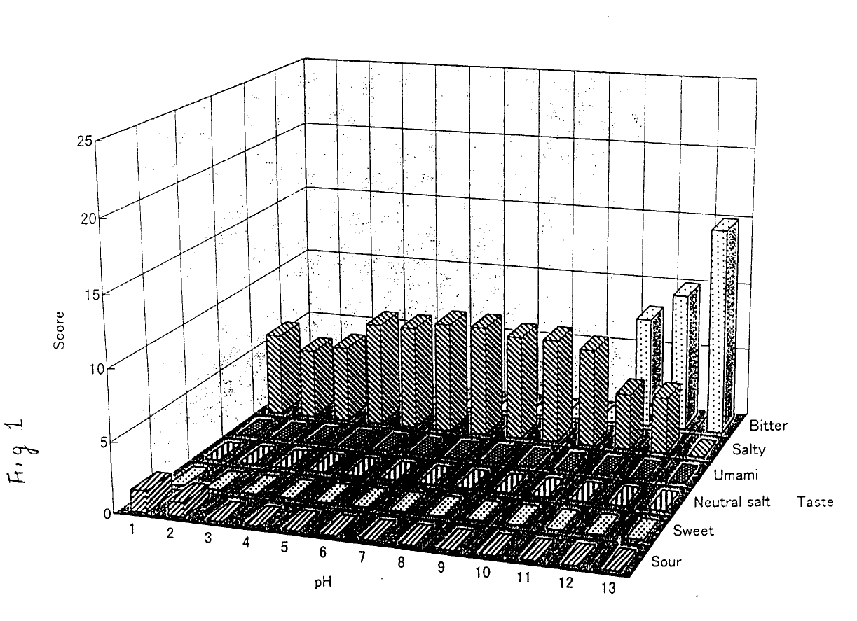

In order to examine more directly the effect of ion concentration on taste, the inventor carried out a series of experiments in which the volume rations of anions and cations of a representative neutral salts in a dense solution was varied and the changes in several taste qualities, namely sourness, sweetness, neutral salt taste, saltiness, and bitterness as a function of Ph were evaluated. It was found that for NaCl, saltiness was perceived on tasting over a wide range of Ph from pH 2 up to pH 12 with little or no difference in the intensity of the saltiness. Only in the alkaline region above pH 11 was a slight bitterness sensed which increased with increased alkalinity. None of the other taste qualities was noted with an exception of very slight sourness at very low pH's, i. e. pH 1 and 2. The results of this experiments appear graphically in FIG. 1.

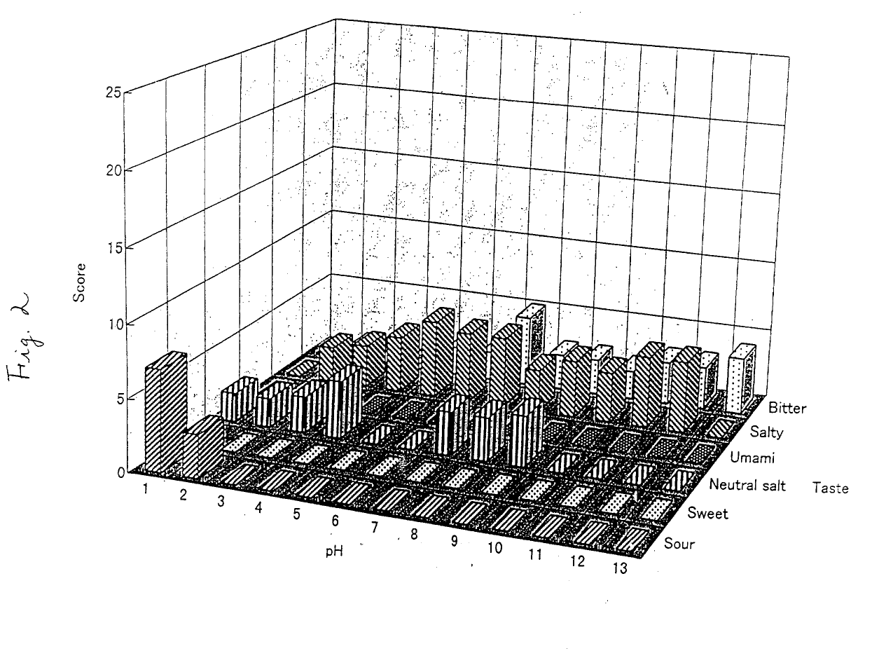

A similar experiment was carried out with potassium chloride (KCl). Despite the close relationship in chemical properties of this salt with NaCl, its behavior in taste characteristics was remarkable different. As regards saltiness, KCl behaved quite similar to NaCl, conveying saltiness over the same broad pH range with only minor differences in intensity perceived. The outcome was very different in the case of bitterness, however, this quality being perceived from about neutral pH, e. g. pH 7, through the strong alkaline level of pH 13 with about the same, or even occasionally higher, as for NaCl. Moreover, the neutral salt effect was much stronger than for NaCl over about the lower half of the pH range, equaling or even exceeding saltiness, but in a manner quite different from a desirable Umami effect that was not at all pleasant in the mouth. And sourness was much stronger at very low pH's. On the whole, the taste characteristics of KCl are very different from those of NaCl, as can be seen in FIG. 2.

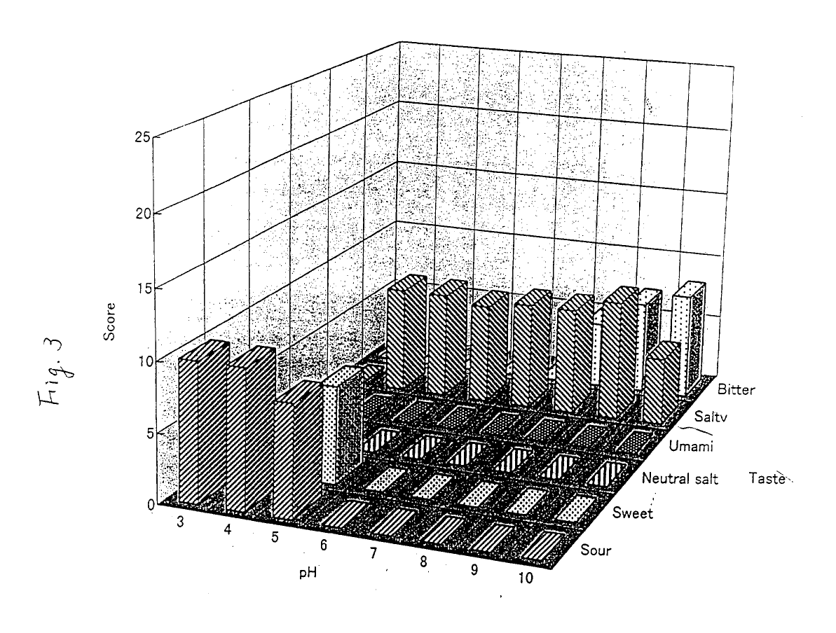

In the case of sodium acetate, differences also appeared, following more closely the pattern of KCl with some slight variations such as a stronger bitterness at very high pH's rather like NaCl but a stronger sourness, and even some sweetness, at quite low pH's. These qualities can be visualized in FIG. 3.

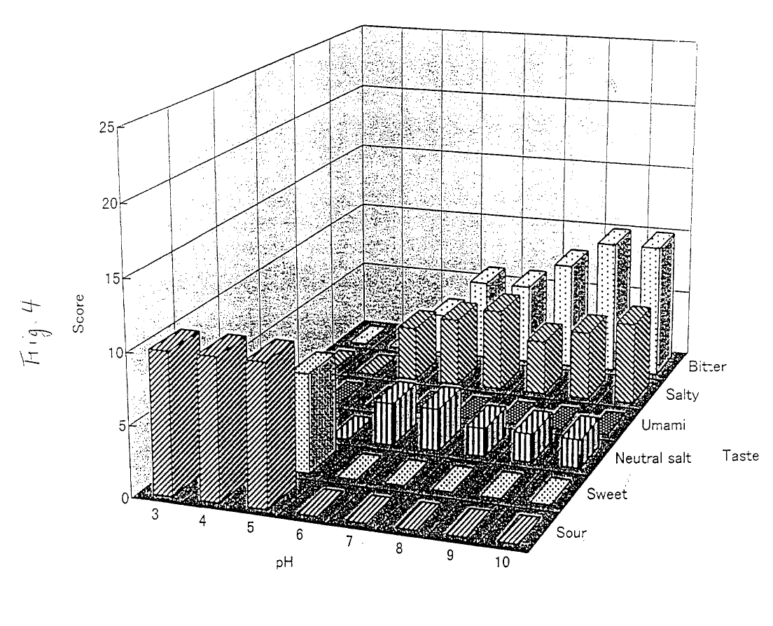

The results found for sodium citrate are even more complicated, saltiness, bitterness, and neutral salt effect being presented in roughly the upper half of the pH range, i.e. from about pH 6 upwards, and strong sourness with a touch of sweetness at low pH's up to about pH 5. See FIG. 4. Thus, in about neutral pH region, these competing taste characteristics were at a minimum, meaning that in about the neutral pH region, the inherent taste characteristics of sodium citrate were roughly “neutral”. This “split” or division in taste qualities for sodium citrate at a certain pH level appeared to be unique for sodium citrate.

In the light of this obviously complex behavior of neutral salts as regards their taste characteristics, the inventor has concluded that their action is a composite of three distinct patterns. In the case of neutral salts giving the Umami effect, the best known example of which is MSG, an important characteristic is that they do not manifest a pleasant taste by themselves, i. .e when utilized alone, but present a desirable pleasant taste only when combined with NaCl. This particular pattern can be referred to as “miscibility” with NaCl.

On the other hand, those neutral salts such as sodium acetate which do not necessarily possess a pleasant taste in themselves can when mixed with NaCl or another neutral salt in order to expand the taste pattern of the latter to include sweetness or bitterness. This pattern can be designated as “mixed tastes”.

Finally, there are neutral salts which when present alone have no distinct flavor of their own, whether saltiness, bitterness, or otherwise, but when combined with table salt, a quality that was apparently latent becomes realized. This can perhaps be understood by reference to “beef bouillon” which is a favorite among many westerners. In fact, “beef bouillon”, i. e. the pure beef extract, has little or no taste of its own. Only with the addition of a small amount of salt or some other seasoning does its pleasing taste become forth. It may be said that while the Japanese developed Umami based on its affinity with NaCl and consider this quality preferred, westerners tend to find the taste-improving action of beef bouillon to be superior.

Problems to be Solved by the Invention:

As a rule, available flavor-enhancing agents exhibit their contribution as a function of the amount with strong enhancement requiring addition of large quantities, and often increasingly large additions as the taste perception of particular individuals fades or becomes “jaded”. This can easily lead to an excessive consumption of sodium since most of these contain sodium ions,. It is now well established that heavy consumption of sodium can have serious health consequences, leading to hypertension and ultimately coronary problems. Nor is the situation much better with regard to sweetness which for most people means sugar, in that heavy intake of sugar can lead to obesity or adult-onset disorders. Clearly from the evidence set forth above, substitution of potassium chloride cannot be an acceptable solution for the general population.

Attempts have been made to circumvent this situation by reducing the level of sodium in so-called “low salt” products or a “low salt diet”. But this approach has proved to be virtually self-defeating because such foods suffer serious taste loss from the decrease in sodium content and have little appeal to most consumers who either defeat the benefit by adding salt themselves or choosing more tasteful replacements with higher salt content.

In another category of flavoring additives, their contribution is dependent upon some peculiar taste of their own which can either override the inherent taste of the food being treated or undesirably modify that inherent taste in some less appetizing way. Moreover, one must evaluate in advance how the inherent flavor of specific foods and the new flavor of the additive will interrelate and how to adjust the relative quantities to reach an appealing balance.

Object of the Invention:

The object of the invention is a flavor-improving agent that, on the one hand, is free of sodium ions and hence avoids the drawbacks associated with such ions and on the other hand has no distinctive taste of its own so that its presence does not degrade the inherent flavor of the foodstuff to which it is added.

Explanation of the Invention:

The inventor believes that beef bouillon consists essentially of a mixture of peptides that has “seeped” or dissolved, perhaps as colloidal particles, into the aqueous solution as its protein has been partially hydrolyzed. He has studied the taste influence of a number of “tasteless” neutral salts and, as a consequence, discovered that a certain neutral salt formed by a mixture of ornithyl taurine and glutaric acid was “tasteless” and held promise as a taste-improving agent. However, there are a number of formidable problems to be overcome in any practical scale production of such novel but complex peptides at a reasonable cost not to mention obtaining safety clearance from governmental regulators.

Faced with such difficulties, the inventor resorted to an examination of neutral salts that are at least essentially “tasteless” from among those already approved by the Japanese Government for food additive use. This examination led to the identification of neutral salts derived from citric acid and a basic amino acid such as arginine or ornithine. The choice of citric acid as the ;acidic component of such salts was motivated by the “reversal” in taste characteristics of this acid in the generally neutral region, as already described. The following three specific substantially tasteless neutral salts were found to offer useful “taste-improving” action under the protocol of this invention: the salt of citric acid with arginine (arginine citrate), the salt of citric acid with ornithine (ornithine citrate), and the salt of citric acid with lysine (an isolog of ornithine) (lysine citrate). To these, the names have been respectively given: Arcite, Orcite, and Lyscite. It is imaginable that other basic amino acids than these three which similarly yield essentially tasteless basic neutral salts upon reaction with citric acid may be found to behave comparably in association with food or drug products and its should be understood thast the invention is intended to cover these as well.

Preparation of Free Amino Acids for of the Invention:

Commercially available basic amino acids suitable for this invention are usually sold as salts of hydrochloric acid so that in order for the free amino acids to be obtained, the anions of such salts must be removed. This can be done by dissolving an appropriate quantity, such as 0.1 mol, of the hydrochloride in water and contacting the solution with a suitable amount (such as 1000 ml) of a weak acid ion exchange resin, e. g. an Amberlite IR-120 H+ type resin to give an exchange volume X 5 times or more, and then washing the resin to recover the free amino acid. With sufficient drying, the free amino acid can be obtained in crystal form.

Obviously, this preparation procedure can be dispensed with if free amino acid of 95% purity or better is commercially available. Citric acid is of course commercially available in essentially pure state.

Preparation of the Taste-Improving Agents of the Invention:

Generally speaking, to produce the agents of this invention, an amount of citric acid is combined with an amount of the selected basic amino acid falling within a molar ratio range of 1-3 to 3-1. The specific molar ratio selected within these ranges is best determined under practical circumstances for the particular foodstuff and particular conditions for which the agent is to be added. This is because the most favorable ratio may very well be different for different food compositions. In choosing a precise ratio, consideration should be given to the following objectives: reducing bitterness, intensifying saltiness, increasing sweetness and achieving an overall harmony or balance between all taste characteristics. As one specific example, for addition to candy, a molar ratio of citric acid to arginine of 1:3 has proved quite beneficial.

The neutral salts of the invention are easily produced from the free basic amino acid and citric acid. All that is done to add the amino acid and citric acid to a small amount of water and mix with stirring if need be under complete dissolution occurs. To this solution, either ethanol or a mixture of ethanol and water is added to cause deposition of the neutral salt. In many instances, the deposit is in an oily form but on sufficient drying, a hygroscopic deposit results at a yield generally of 80-100%.

Taste Characteristics of Free Basic Amino Acids Per Be:

Free arginine in its original form is not palatable and its hydrochloride salt is bitter. Both ornithine and lysine in their free forms have pungent taste due to their basic state but their hydrochloride salts are relatively tasteless. When converted to dense solutions (in excess of 10⁻² M), they are bitter. Neutral salts with citric acid Arcite and Orcite (to use their coined names) are both essentially tasteless in the neutral region (pH 5.5-pH 6.5). Their overall taste quality is in the order of Orcite, Lyscite, Arcite.

Comparative Taste Tests:

### Example 1

### Arcite-Candies

Arcite prepared as described in the preceding section at a molar ratio of 3:1 of arginine to citric acid was added at a level of 1% by wt of total candy ingredients to bitter herb candy and full bodied milk candy. To prepare the milk candy, first, a candy base is made of syrup and “Mizume syrup” (a syrup made from starch decomposed by an acid or saccharifying enzyme), to which is added a mixture of skimmed mild, condensed milk and emulsified butter. Then, the resultant mixture is condensed under reduced pressure until a water content of 5% by wt is reached.

A test panel consisting of 5 men and 5 women were instructed to taste samples of each of the arcite-containing candies with the same candy free of arcite and to rate the respective samples on a scale of 1-5, with 5 representing the highest score. They were also requested to Vote on the same scale for the candy that was overall more appealing to them. The test scores were combined for each sample to give a numerical (albeit subjective) rating and these ratings are set forth in the following tables 1 and 2 for the different candies and in table 3 for the overall preference. From the tables, it will be seen that the saltiness and Umami was improved for both candies together with an increase in sweetness aftertaste, but not in sweetness directly. Overall, the candies modified according to the invention were deemed preferable to the original candies by a margin of almost 2/1. Clearly. based on this evaluation, the addition of Arcite yielded an improved candy of either type.

TABLE 2
Herb Candy - Specific Characterisics:

| | Sweet- | Salti- | Sour- | Bitter- | | Sweetness | |
|---|---|---|---|---|---|---|---|
| Arcite | ness | ness | ness | ness | Umami | Aftertaste | Body |
| Not | 25 | 5 | 10 | 16 | 12 | 10 | 13 |
| Added | | | | | | | |
| Added | 27 | 10 | 8 | 12 | 18 | 21 | 10 |

TABLE 2
Milk Candy - Specific Characteristics:

| | | | | | | | |
|---|---|---|---|---|---|---|---|
| Not | 32 | 8 | 3 | 0 | 18 | 7 | 26 |
| Added | | | | | | | |
| Added | 35 | 14 | 2 | 0 | 24 | 18 | 16 |

TABLE 3
Above Candies - Overall Appeal

| | |
|---|---|
| Herb Candy | Milk Candy |

| Arcite | Men | Women | Men | Women | Total |
|---|---|---|---|---|---|
| Not Added | 8 | 5 | 6 | 8 | 21 |
| Added | 12 | 15 | 14 | 12 | 53 |

### Example 2

### Orcite-Sports Drink:

Orcite prepared in above at a molar ratio of 2:1 was added at a level of 1% to a common commercial sports drink containing added sugar, citric acid, vitamins, and minerals such as magnesium and calcium which impart to the drink a slight bitterness. A test panel of 5 men and 5 women were instructed to evaluate the drink with an without the addition and, again, to vote which was preferred from an overall standpoint. The results are summarized in the following tables 4 and 5. While the change in specific taste factors appeared to be less dramatic than with the candies, there was a strong reduction in bitterness and sweetness aftertaste while the overall improvement was judged even greater than in the previous case.

TABLE 4
Orcite - Sports Drink - Specific Characteristics:

| | Sweet- | Salti- | Sour- | Bitter- | Sweetness | |
|---|---|---|---|---|---|---|
| Orcite | ness | ness | ness | ness | Aftertaste | Body |
| Not | 25 | 5 | 10 | 5 | 10 | 13 |
| Added | | | | | | |
| Added | 27 | 8 | 8 | 0 | 15 | 10 |

TABLE 5
Orcite - Sports Drink - Overall Comparison:

Sports Drink

| Orcite | Men | Women | Total |
|---|---|---|---|
| Not | 4 | 5 | 9 |
| Added | | | |
| Added | 16 | 15 | 31 |

### Example 3

### Lyscite-Commercial Low-Salt Soy Sauce:

Lyscite prepared in above at a molar ratio of 3:1 was added at a level of 1% by wt to a commercial low-salt soy sauce and a test panel of 5 men and 5 women were instructed to evaluate specific taste characteristic of the soy sauce with and without the addition in the same manner as in earlier tests. The results are given in table 6 which shows a definite increase in perceived “saltiness” along with reduced bitterness and higher Umami. Hence, one can conclude that the addition of one of the agents of the invention can greatly compensate for the lowered salt content of the soy sauce without loss in the health advantages thereof.

TABLE 6
Lyscite - Low Salt Soy Sauce:

| Lyscite | Sweetness | Saltiness | Sourness | Bitterness | Umami | Body |
|---|---|---|---|---|---|---|
| Not | 5 | 20 | 10 | 16 | 27 | 13 |
| Added | | | | | | |
| Added | 5 | 28 | 8 | 12 | 36 | 12 |

### Example 4

### Lyscite-Various Condiments:

Lyscite prepared as above at a molar ratio of 3:1 was added at a level of 1% by wt to each of a ketchup, mayonnaise, and Worcester sauce, all commercially available products, and a test panel of 5 men and 5 women was instructed to evaluate specific taste characteristics of these condiments with and without the addition of the agent in the same manner as in earlier tests. The results are given in tables 7-9. It can be seen that the effect of the agent extended to these products, not withstanding their thick pasty or emulsified state. In general, the saltiness and Umami were increased in all instances together with a reduction in sourness which was less pronounced in the Worcester sauce (despite the inherent greater sourness of the latter.

TABLE 7
Ketchup - Specific Characteristics:

| | Sweet- | | | Bitter- | | | |
|---|---|---|---|---|---|---|---|
| Arcite | ness | Saltiness | Sourness | ness | Umami | Hotness | Body |
| Not | 10 | 20 | 15 | 4 | 17 | 22 | 16 |
| Added | | | | | | | |
| Added | 12 | 26 | 8 | 4 | 23 | 27 | 13 |

TABLE 8
Mayonnaise - Specific Characterisitics:

| | Sweet- | | | Bitter- | | | |
|---|---|---|---|---|---|---|---|
| Arcite | ness | Saltiness | Sourness | ness | Umami | Hotness | Body |
| Not | 5 | 15 | 18 | 3 | 14 | 20 | 15 |
| Added | | | | | | | |
| Added | 12 | 26 | 8 | 4 | 23 | 27 | 13 |

TABLE 9
Worcester Sauce - Specific Characterisitics:

| | Sweet- | | | Bitter- | | | |
|---|---|---|---|---|---|---|---|
| Arcite | ness | Saltiness | Sourness | ness | Umami | Hotness | Body |
| Not | 5 | 15 | 9 | 1 | 27 | 27 | 28 |
| Added | | | | | | | |
| Added | 5 | 19 | 8 | 1 | 36 | 34 | 27 |

### Example 5

### Arcite-Table Salt:

Arcite prepared as above at a molar ratio of 3/1 was added at a level of 1% by wt to commercially available table salt, and a test panel of 5 men and 5 women were instructed to judge certain specific taste characteristics of the table salt with and without the addition of the agent in the same manner as in earlier tests. The results appear in table 10 below and one will note the radically enhanced saltiness of the salt but without any change in its sourness or bitterness.

TABLE 10
Arcite - Specific Characteristics:

| Arcite | Saltiness | Sourness | Bitterness |
|---|---|---|---|
| Not | 20 | 0 | 0 |
| Added | | | |
| Added | 46 | 0 | 0 |

Scope of the Invention:

Virtually any kind of foodstuff or food product can be used in the practice of the invention with the proviso that the state or condition of the product reasonably lends itself to the addition of the additive. This does not imply that all food products will be improved to the same degree or will be improved with the same amount of the agent, as already pointed out. By and large, the amount of the agent of the invention that needs to be added to the food product to achieve a significant benefit in accordance with the invention appears to fall within the range of about 1-5% by wt of the product has been effective but since not all products have been evaluated, amounts outside of this range may conceivably prove preferable.

Of the products so far examined and for all of the basic salts of the invention irrespective of the basic amino acid selected, about 1% by wt of the agent has given satisfactory results, although the balance in taste characteristics of a specific product after treatment may vary somewhat for the different amino acids. If at a particular level for a specific product, little or no improvement in the desired characteristics of the product in question is found, it is a reasonable assumption that the amount is too small and larger amounts should be considered. On the other hand, as a rule, once a desirable level has been identified, further increase in the amount has not been found to bring about a concomitant improvement in results. Obviously, the effect of a specific agent at a specific level with a particular food product or drug agent can very easily be ascertained by the most routine experimentation using a simple “taste test”, bearing in mind the fact that, as mentioned earlier, taste evaluations tend to have a subjective factor under any circumstances, which is especially true for taste characteristices which are rather subtle in nature, as may be the case here. Hence, as suggested by the above examples, a more reliable judgment may be obtained with a plurality of subjects rather than a single individual.

All this being said, a broad and diverse field of food products are adapted to this invention. Among these can be listed (without any intention of all-inclusiveness): seasonings such as soy sauce in both liquid and solid form whether low-salt or not, and other soy derivatives such as tofu, unrefined soy sauce and fish soy sauce, Miso-soybean paste in paste or powder form, table salt and flavored salts such as pepper salt, lemon salt, garlic salt, onion salt and the like, powdered egg yolk, condiments such as ketchup, mayonnaise, salad dressings of various flavors, vinegar in liquid or powder form both natural and seasoned, seasonings for Chinese dishes, dip sauces for fried seafood and noodles, Worcester sauce, barbecue sauces of varying composition, curry, bases for stews, powdered or cubed soups, bouillon bases, sweet sake seasoning; table sugar, coffee sugar; various Japanese sweets made of rice, red beans, sugar, etc.; various Western sweets made of flour, butter, eggs, etc.; ice creams including low fat and sherbets; honey, syrups and fruits in syrup; various pastes of fruit, sesame, starch, seafood, and nuts; processed fruits and vegetables such as jams, marmalades, sugared fruits, various types and flavors of pickles, fish and seafood products such as fish sausages and pastes. cooked seafood, fish, meats, vegetables, fruit, etc. as such or bottled and canned; tidbits, “snacks”, crackers and the like for sake and alcoholic drinks; dairy products such as milk, yogurt, cheese, whey, cream, butter, margarine, etc.; alcoholic beverages such as sake, various spirits, wine, brandy, whiskey, vodka whether plain or flavored, synthetic alcoholic drinks, beer or other brewed beverages, fruit wine, and medicinal wines; green tea, black tea, and flavored teas, coffee, cocoa, soft drinks including juices, carbonated drinks and yogurt drinks; pre-mixes for puddings, pan cakes, waffles and so on; powdered beverage mixes for juices, coffee, tea, lemonade, red bean drinks and soups; frozen foods and retort pouched foods; nuts such as peanuts, almonds, cashew nuts, etc.; lecithin, processed potatoes and fish; various noodles, pastas and cereals; royal jelly; powdered foods such as bouillon, fish powders, blood powders, bone powders and the like; spices such as paprika, cinnamon, nutmeg, black pepper, flavored peppers, herbs, sage, peppermint, Japanese horseradish, garlic, mustard, Japanese pepper, and laurel; food extracts such as yeast extract, propolis extract, medicinal carrot extracts, snapping turtle extracts, vegetable extracts, oyster extract, bonito extract, beef and other meat extracts, seaweed extract, chicken extract; mushroom extract, licorice extract, stevia extract, chlorella extract, and aloe extract, and their enzyme processed products; food colorings containing one or more colorings extracted from madder, annatto, turmeric, red beet, safflower, gardenia, saffron, and red koji; low-sugar, low-salt and low-sodium jams, jellies and other dietary products; vitamins and dietary supplements such as vitamin C, calcium, iron and so on; and special purpose foods for the elderly or those on restricted diets.

The invention is not limited to food and other edibles but extends to other substances or products intended for human ingestion, notably pharmaceuticals or drugs for oral administration and especially those marked by an unpleasant tastes such as bitterness or sourness such as Chinese and Japanese indigenous drugs such as swertia herb and pyrine to mention just a few. Because the agents of this invention consist essentially of neutral salts, they have little or no tendency to react with pharmaceuticals or otherwise interfere with the desired pharmaceutical action. Rather, the present agents are believed to act primarily on the taste receptors of humans and soften or “relax” the sensitivity or response of those receptors to any sharp tastes that may be found in pharmaceuticals without, in any event, affecting their pharmaceutical mechanism.

The addition to or incorporation in a particular food product or pharmaceutical substance of a selected agent within the invention presents little or no problem. For those products which are liquid or have a significant liquid content, the present agents which are in powdered form can easily be dissolved or dispersed by stirring in the liquid, depending upon compatibility with the liquid. For solids which are finely divided, the powdered agent hypertension. The present agents can offer the possibility of reversing this trend, given their valuable property of increasing the taste perception of saltiness in foods without increasing the actual sodium content, thereby making the foods more palatable and appealing in the mouth.

As regards their utility the pharmaceutical field, it is well known that neutral salts are already being employed as buffering agents, sodium chloride being paramount for this purpose. Hence, the present neutral salts should offer no problem when combined with pharmaceuticals or drugs and, moreover, have the significant advantage of being.;sodium free. The basic amino acids and organic acid serving as starting ingredients are all decomposed in the living body and, consequently, would not have significant adverse effects even if excessive intake of the present agent should occur.

Indeed, the ingredients of this invention are recognized as possessing valuable health properties. Arginine (the basic amino acid of Arcite) is reported to have hypotensive (vasodilation) action leading to improved circulation of the blood and lowering the risk of arteriosclerosis. It serves to activate the urea cycle, improving the immune function, lowering ammonia, and acting to stimulate insulin gulkagopin secretion. Lysine is pharmacologically effective in promoting calcium absorption and aspirin dissolution, and is already in use in the pharmaceutical field. As for ornithine (present in Orcite), it is the intermediate metabolite of arginine in the urea cycle and is expected to behave correspondingly to arginine. Organic acids such as citric acid is said to be effective in recovery from fatigue by activation of the TCA cycle.

It can be concluded therefore that the basic neutral salts of the invention are not merely medicinally innocuous but may actually possess valuable properties when consumed by humans.

1. A method of improving the taste characteristics of food products for human consumption or pharmaceutical products for oral administration, which comprises the step of adding to such products a small amount of a basic neutral salt obtained by reacting citric acid with a basic amino acid yielding with citric acid an essentially tasteless salt.

2. The method of claim 1 wherein said basic amino acid is selected from the group consisting of arginine, lysin, and ornithine.

3. The method of claim 1 wherein said citric acid and said basic amino acid are reacted at a molar ratio selected within the range of 1-3 citric acid to 3-1 basic amino acid.

4. The method of claim 3 wherein said basic amino acid is arginine and the reaction ratio is 1:3 of basic amino acid to citric acid.

5. A taste-improving agent for food products and pharmaceutical products administered orally which comprises a basic neutral salt obtained by reacting citric acid with a basic amino acid yielding with citric acid an essentially tasteless salt.

6. The agent of claim 1 wherein said basic amino acid is selected from the group consisting of arginine, lysin, and ornithine.

7. The agent of claim 5 wherein said citric acid and said basic amino salt are reacted at a molar ratio within the range of 1-3 citric acid to 3-1 basic amino acid.

8. The agent of claim 7 wherein said basic amino acid is arginine and the molar ratio is 1:3 of basic amino acid to citric acid.

9. A food or pharmaceutical product for oral consumption by humans having improved taste characteristics and containing a minor amount of a taste-improving agent according to claim 5.

10. A food or pharmaceutical product for oral consumption by humans having improved taste characteristics and containing a minor amount of a taste-improving agent according to claim 6.
